(19) United States
(12) Patent Application Publication
(10) Pub. No.: US 2017/0111636 A1
(43) Pub. Date: Apr. 20, 2017

(54) INFORMATION PROCESSING APPARATUS, INFORMATION PROCESSING METHOD, COMPUTER PROGRAM, AND IMAGE DISPLAY SYSTEM

(71) Applicant: Sony Corporation, Tokyo (JP)

(72) Inventors: Yuichi Hasegawa, Tokyo (JP); Yukio Oobuchi, Kanagawa (JP)

(73) Assignee: Sony Corporation, Tokyo (JP)

(21) Appl. No.: 15/318,116

(22) PCT Filed: Jun. 17, 2015
(86) PCT No.: PCT/JP2015/003033

§ 371 Date: Dec. 12, 2016

(30) Foreign Application Priority Data
Jul. 28, 2014 (JP) 2014-153351

(51) Int. Cl. H04N 17/04; G06T 7/285; G06T 7/60; H04N 13/04; G06T 7/70

(52) U.S. Cl. CPC H04N 17/04; H04N 13/0429; G06T 7/70; G06T 7/60; G06T 7/285; H04N 2213/002; G06T 19/006

(57) ABSTRACT

An image processing apparatus may include a control device configured to detect an abnormality in accordance with at least one of (i) position or orientation information of a display or (ii) information indicating movement of HEAD MOTION an image of contents to be displayed to the display; and generate a free viewpoint image in accordance with the image of contents and the position or orientation information of the display.

### CROSS REFERENCE TO RELATED APPLICATIONS

This application claims the benefit of Japanese Priority Patent Application JP 2014-153351 filed Jul. 28, 2014, the entire contents of which are incorporated herein by reference.

### TECHNICAL FIELD

The technology disclosed in embodiments of the present description relates to an information processing apparatus, an information processing method, a computer program, and an image display system, which perform processing on image information that is to be displayed on a screen fixed to a head or a face of a user.

### BACKGROUND ART

An image display device that is fixed to a head or a face of a user viewing an image, in other words, a head mounted display, is known. The head mounted display includes, for example, an image display unit for each of the left and right eyes and is configured so as to be capable of controlling visual and auditory senses by using a headphone together with the head mounted display. By configuring the head mounted display to completely cut off the external environment when the head mounted display is mounted on the head, virtual reality during viewing increases. Furthermore, the head mounted display can project different images on the left and right eyes such that by displaying parallax images to the left and right eyes, a 3-D image can be presented.

Such a type of head mounted display forms a virtual image on a retina of each of the eyes for the user to view. In the above, when an object is positioned near the lens with respect to the focal length, a virtual image is formed on the object side. For example, a head mounted display with a wide angle of visibility has been proposed in which a magnified virtual image of a display image is formed in each pupil of a user by disposing a virtual image optical system with a wide angle of visibility 25 mm in front of each pupil and by disposing a display panel having an effective pixel range of 0.7 inches further in front of each optical system with the wide angle of visibility (see PTL 1, for example).

Furthermore, by using the above type of head mounted display, the user can view an image that has been extracted partially from an image having a wide field of view. For example, head mounted displays have been proposed in which a head motion tracking device including a gyro sensor is attached to the head so as to allow a user to feel like a wide field-of-view image following a movement of a head of a user is real (see PTL 2 and PTL 3, for example). By moving the display area in the wide field-of-view image so as to cancel out the movement of the head that has been detected by the gyro sensor, an image following the movement of the head can be reproduced such that the user undergoes an experience of looking out over a large space.

Incidentally, in an image display system that displays a virtual image, it is known that there is a risk of causing health damage, such as virtual reality (VR) sickness, to the user when an unexpected image that does not match the movement of the user is viewed.

For example, when playing a video game, which has been rendered by three-dimensional computer graphics, on a large screen display or when continuously viewing a 3-D movie for a long time on a three-dimensional television capable of providing a stereoscopic vision, there are cases in which the user feels sick. Furthermore, even when viewing a free viewpoint image for a relatively short time, simulation sickness is easily caused in a head mounted display with a wide angle of visibility.

### SUMMARY OF INVENTION

### Technical Problem

It is desirable to provide an information processing apparatus, an information processing method, a computer program, and an image display system that are excellent and are capable of preventing simulation sickness caused during viewing by processing an image that is to be displayed on a screen fixed to a head or a face of a user.

### Solution to Problem

According to an embodiment of the present disclosure, an image processing apparatus may include a control device configured to detect an abnormality in accordance with at least one of (i) position or orientation information of a display or (ii) information indicating movement of an image of contents to be displayed to the display; and generate a free viewpoint image in accordance with the image of contents and the position or orientation information of the display.

According to an embodiment of the present disclosure, an image processing method may include detecting, by a processing device, an abnormality in accordance with at least one of (i) position or orientation information of a display or (ii) information indicating movement of an image of contents to be displayed to the display; and generating, by the processing device, a free viewpoint image in accordance with the image of contents and the position or orientation information of the display.

According to an embodiment of the present disclosure, a non-transitory storage medium may be recorded with a program executable by a computer. The program may include detecting an abnormality in accordance with at least one of (i) position or orientation information of a display or (ii) information indicating movement of an image of contents to be displayed to the display; and generating a free viewpoint image in accordance with the image of contents and the position or orientation information of the display.

According to an embodiment of the present disclosure, an image processing apparatus may include a control device configured to: detect an abnormality in accordance with information indicating movement of an image of contents to be displayed, using a threshold value indicated in metadata related to the contents.

According to an embodiment of the present disclosure, an image processing method may include detecting, by a processing device, an abnormality in accordance with information indicating movement of an image of contents to be displayed, using a threshold value indicated in metadata of the contents.

### Advantageous Effects of Invention

One or more of embodiments of the technology disclosed in the present description can provide an information processing apparatus, an information processing method, a computer program, and an image display system that are excellent and are capable of preventing simulation sickness from being caused during viewing by processing an image that is to be displayed on a screen fixed to a head or a face of a user.

In addition, the effects described in the present specification are merely illustrative and demonstrative, and not imitative. In other words, the technology according to the present disclosure can exhibit other effects that are evident to those skilled in the art along with or instead of the effects based on the present specification.

The aim, features, and advantages of the present disclosure will be made clear later by a more detailed explanation that is based on the embodiments of the present disclosure and the appended drawings.

### BRIEF DESCRIPTION OF DRAWINGS

FIG. 1 is a diagram schematically illustrating an exemplary configuration of an image display system 100 to which an embodiment of the technology disclosed in the present disclosure has been applied.

FIG. 2 is a diagram schematically illustrating a modification of the image display system 100.

FIG. 3 is a diagram illustrating a state in which a user mounting a head mounted display on the head is viewed from the front.

FIG. 4 is a diagram illustrating a state in which the user wearing the head mounted display illustrated in FIG. 3 is viewed from above.

FIG. 5 is a diagram illustrating a modification of the image display system 100 using the head mounted display.

FIG. 6 is a diagram illustrating an exemplary functional configuration of the image display system 100 illustrated in FIG. 5.

FIG. 7 is a diagram for describing a mechanism that displays an image that follows the movement of the head of the user with the display device 400.

FIG. 8 is a diagram illustrating a procedure for cutting out, from a wide visual field image, an image having a display angle of view that matches the position and orientation of the head of the user.

FIG. 9 is a diagram illustrating an exemplary functional configuration that automatically detects an abnormal image.

FIG. 10 is a diagram illustrating a coordinate system of the head of the user.

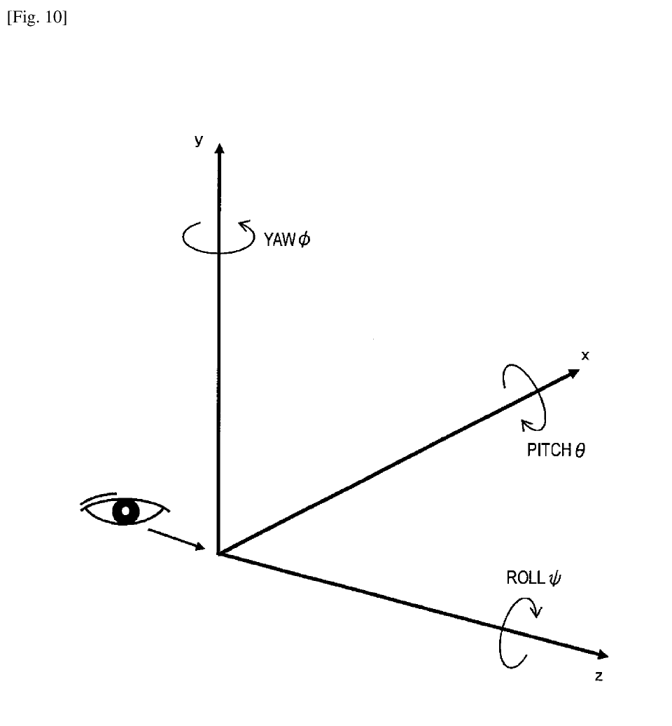

FIG. 11 illustrates another exemplary functional configuration that automatically detects an abnormal image.

FIG. 12 illustrates further another exemplary functional configuration that automatically detects an abnormal image.

FIG. 13 is a diagram exemplifying optic flows generated in a plane of the image.

### DESCRIPTION OF EMBODIMENTS

Hereinafter, an embodiment of the technology disclosed in the present description will be described in detail with reference to the drawings.

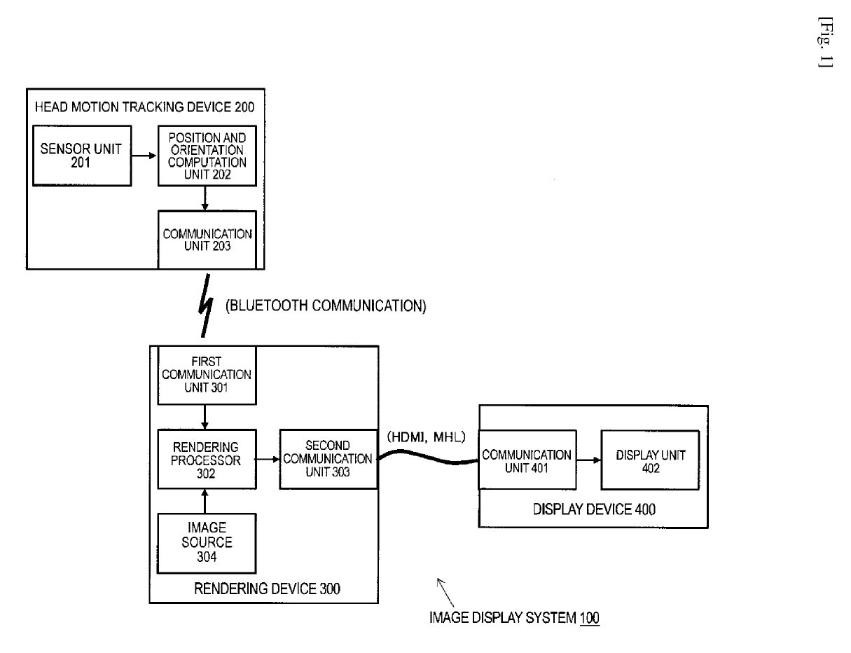

FIG. 1 schematically illustrates an exemplary configuration of an image display system 100 to which an embodiment of the technology disclosed in the present disclosure has been applied. An image display system 100 illustrated in the drawing includes a head motion tracking device 200, a rendering device 300, and a display device 400.

The head motion tracking device 200 is used by being mounted on a head of a user viewing an image that is displayed by the display device 400 and outputs position and orientation information of the head of the user at predetermined transmission periods to the rendering device 300. In the illustrated example, the head motion tracking device 200 includes a sensor unit 201, a position and orientation computation unit 202, and a communication unit 203 that transmits the obtained orientation information to the rendering device 300.

The sensor unit 201 is constituted by combining a plurality of sensor elements such as a gyro sensor, an acceleration sensor, and a geomagnetic sensor. Herein, the sensors are a triaxial gyro sensor, a triaxial acceleration sensor, and a triaxial geomagnetic sensor that are capable of detecting nine axes in total. The position and orientation computation unit 202 computes the position and orientation information of the head of the user on the basis of the result of the detection in nine axes detected by the sensor unit 201. The communication unit 203 transmits the computed orientation information to the rendering device 300.

In the image display system 100 illustrated in FIG. 1, the head motion tracking device 200 and the rendering device 300 are interconnected through wireless communication such as Bluetooth (registered trademark) communication. Needless to say, rather than through wireless communication, the head motion tracking device 200 and the rendering device 300 may be connected to each other through a high-speed cable interface such as a Universal Serial Bus (USB).

The rendering device 300 performs rendering processing of the image that is to be displayed on the display device 400. The rendering device 300 is configured as an Android (registered trademark) based terminal, such as a smart-phone or a tablet computer, as a personal computer, or as a game machine; however, the rendering device 300 is not limited to the above devices.

In the example illustrated in FIG. 1, the rendering device 300 includes a first communication unit 301 that receives orientation information from the head motion tracking device 200, a rendering processor 302 that performs rendering processing of an image on the basis of the orientation information, a second communication unit 303 that transmits the rendered image to the display device 400, and an image source 304 that is a supply source of image data.

The first communication unit 301 receives orientation information from the head motion tracking device 200 through Bluetooth (registered trademark) communication or the like. As described above, the orientation information is expressed by a rotation matrix.

The image source 304 includes, for example, storage devices, such as a hard disk drive (HDD) and a solid state drive (SSD), that record image contents, a media re-production device that reproduces a recording medium such as a Blu-ray (registered trademark) disc, a broadcasting tuner that tunes and receives a digital broadcasting signal, and a communication interface that receives image contents from an Internet server and the like. Alternatively, when the display device 400 is configured as an immersive head mounted display, a video see-through image taken by an outside camera (described later) may be the image source 304.

From the image data of the image source 304, the rendering processor 302 renders an image that is to be displayed on the display device 400 side. The rendering processor 302 renders an image that has been extracted so as to have a display angle of view that corresponds to the orientation information received in the first communication unit 301 from, for example, an original entire celestial sphere image and from an original 4K image having a wide angle of view, which have been supplied from the image source 304.

The rendering device 300 and the display device 400 are connected to each other by a cable such as a High-Definition Multimedia Interface (HDMI, registered trademark) cable or a Mobile High-definition Link (MHL) cable. Alternatively, connection may be made through wireless communication, such as wireless HD or Miracast. The second communication unit 303 uses either one of the channels and transmits the image data rendered by the rendering processor 302 to the display device 400 in an uncompressed state.

The display device 400 includes a communication unit 401 that receives an image from the rendering device 300 and a display unit 402 that displays the received image. The display device 400 is configured as a head mounted display that is fixed to a head or a face of a user viewing an image, for example.

The communication unit 401 receives an uncompressed image data from the rendering device 300 through a channel such as a High-Definition Multimedia Interface (HDMI, registered trademark) cable or a Mobile High-definition Link (MHL) cable. The display unit 402 displays the received image data on a screen.

When the display device 400 is configured as a head mounted display, the display unit 402 will include, for example, left and right screens that are fixed to the left and right eyes of the user such that an image for the left eye and an image for the right eye are displayed. The display unit 402 is configured by a display panel such as a micro display including an organic electro-luminescence (EL) device or a liquid crystal display, or a laser scanning display such as a direct imaging retina display, for example. Furthermore, the display unit 402 includes a virtual image optical unit that magnifies and projects a display image of the display unit 402 and that forms a magnified virtual image having a predetermined angle of view in the pupils of the user.

On the rendering device 300 side, an image that has been extracted so as to have a display angle of view that corresponds to the position and orientation information of the head of the user is rendered from, for example, an original entire celestial sphere image or an original 4K image having a wide angle of view. On the display device 400 side, a display area in the original image is moved so as to cancel out the orientation angle of the head of the user. Accordingly, an image that follows the movement of the head can be reproduced and the user can have an experience of looking out over a large screen. Furthermore, the display device 400 may be configured so as to change the audio output in accordance with the movement of the image.

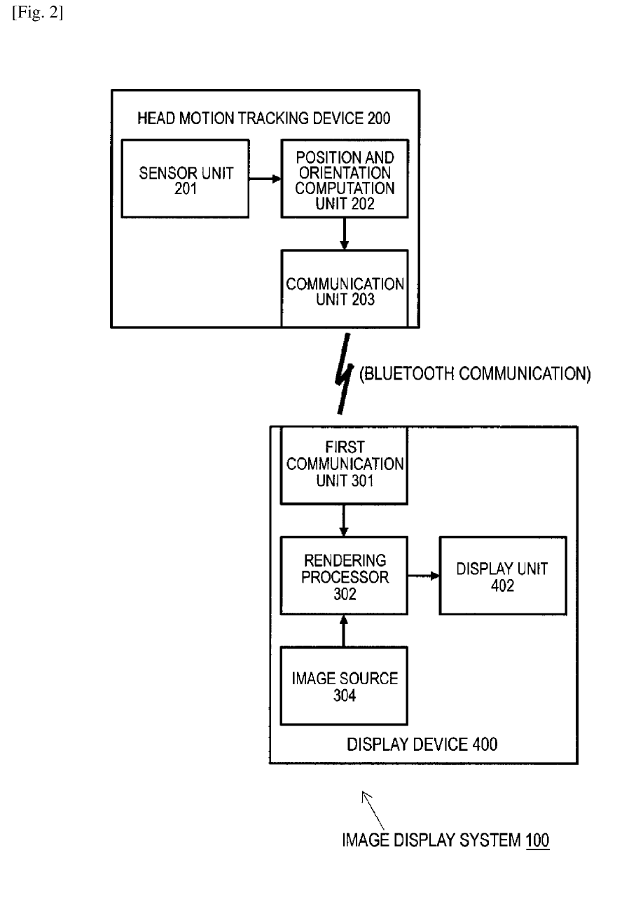

FIG. 2 schematically illustrates a modification of the image display system 100. In the example illustrated in FIG. 1, the image display system 100 includes three separate devices, namely, the head motion tracking device 200, the rendering device 300, and the display device 400; however, in the example illustrated in FIG. 2, the function of the rendering device 300 is equipped in the display device 400. As illustrated in FIG. 1, configuring the head motion tracking device 200 as an optional product that is externally attached to the display device 400 leads to reduction in size, weight, and cost of the display device 400.

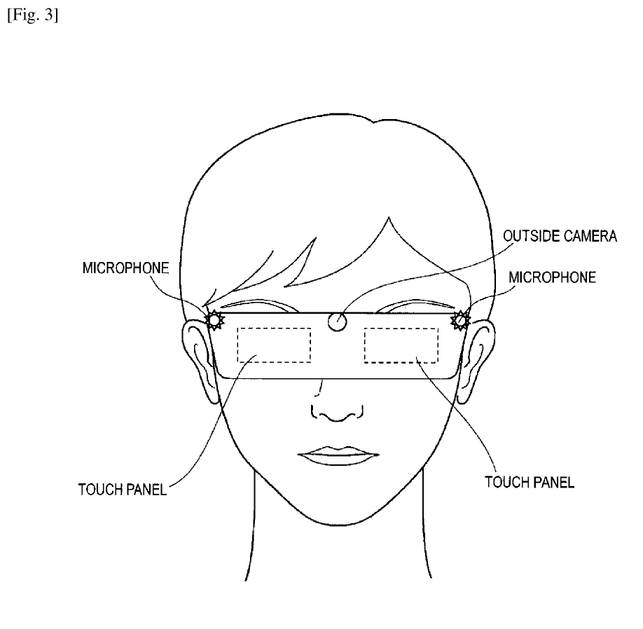

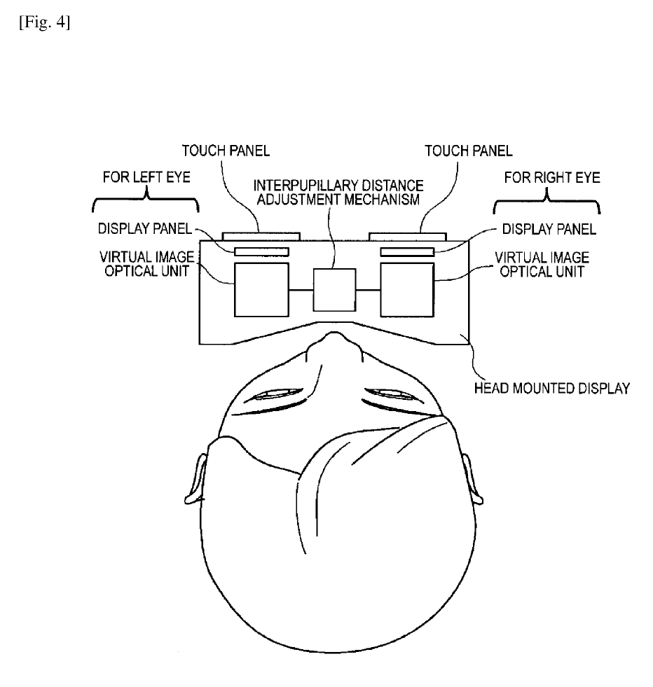

FIGS. 3 and 4 each illustrate an appearance configuration of the display device 400.

In the illustrated example, the display device 400 is configured as a head mounted display that is fixed to a head or a face of a user viewing an image. Note that FIG. 3 illustrates a state in which the user mounting the head mounted display on the head is viewed from the front and FIG. 4 illustrates a state in which the user wearing the head mounted display is viewed from above.

The head mounted display that is mounted on the head or the face of the user directly covers the eyes of the user and is capable of providing a sense of immersion to the user viewing the image. Furthermore, since it is not possible to see the display image from the outside (in other words, by others), while information is displayed, protection of privacy is facilitated. Different from the optical see-through type, it is not possible for the user mounting the immersive head mounted display to directly view the scenery of the actual world. If an outside camera that performs imaging of the scenery in the visual line direction of the user is equipped, by displaying the taken image, the user can indirectly view the scenery of the actual world (in other words, the scenery is displayed through video see-through).

The head mounted display illustrated in FIG. 3 is a structure that has a shape similar to that of a pair of glasses and is configured to directly cover the left and right eyes of the user wearing the head mounted display. Display panels that the user views are disposed on the inner side of a head mounted display body and at positions opposing the left and right eyes. The display panels are each configured by a micro display such as an organic EL device or a liquid crystal display, or by a laser scanning display such as a direct imaging retina display, for example.

Microphones are installed in the vicinities of the left and right ends of the head mounted display body. By having microphones on the left and right in a substantially symmetrical manner and by recognizing only the audio (the voice of the user) oriented at the center, the voice of the user can be separated from the ambient noise and from speech sound of others such that, for example, malfunction during control performed through voice input can be prevented.

Furthermore, touch panels, to which the user can perform touch input with his/her fingertip or the like, are disposed on the outer side of the head mounted display body. In the illustrated example, a pair of left and right touch panels are provided; however, a single or three or more touch panels may be provided.

Furthermore, as illustrated in FIG. 4, the head mounted display includes, on the side opposing the face of the user, display panels for the left and right eyes. The display panels are each configured by a micro display such as an organic EL device or a liquid crystal display, or by a laser scanning display such as a direct imaging retina display, for example. By passing through the virtual image optical unit, the display image on the display panel is viewed by the left and right eyes of the user as a magnified virtual image. Furthermore, since the height of the eyes and the interpupillary distance of each user are individually different, positioning between the eyes of the user wearing the head mounted display and the left and right display systems is to be performed. In the example illustrated in FIG. 4, an interpupillary distance adjustment mechanism is equipped between the display panel for the right eye and the display panel for the left eye.

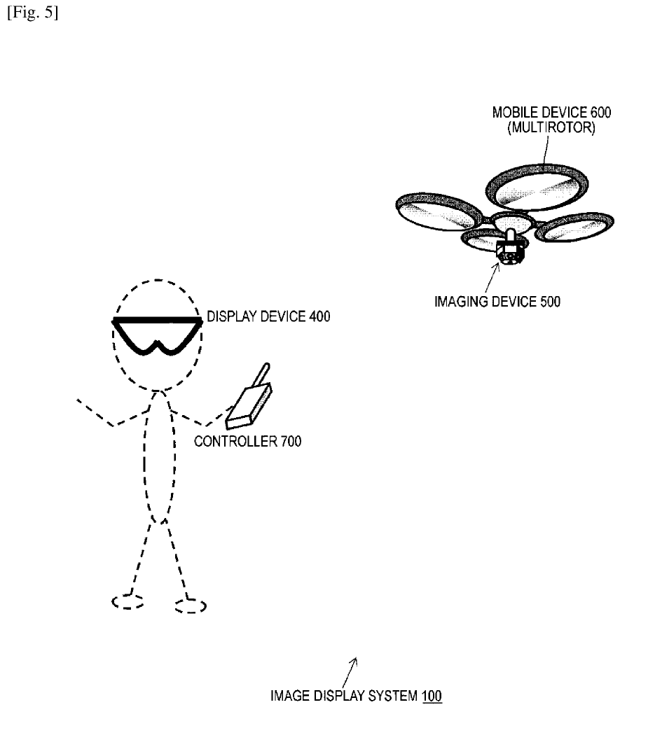

FIG. 5 illustrates a modification of the image display system 100 using the head mounted display. The illustrated image display system 100 includes the display device (the head mounted display) 400 used by the user by being mounted on the head or the face, the head motion tracking device 200 that is not shown in FIG. 5, and an imaging device 500 that is equipped in a mobile device 600 such as a multirotor. The mobile device 600 may be a radio controlled device that is remotely controlled wirelessly by the user through a controller 700, or may be a mobile object piloted by another user or a mobile object that is driven autonomously.

Furthermore, a first person view (FPV) technology is known in which piloting is performed while viewing a first-person viewpoint (a pilot viewpoint) image taken with a wireless camera equipped in a radio controlled device such as a helicopter. For example, a proposal of a mobile object controller including a mobile object equipped with an imaging device, and a wearable PC that is operated by an operator to perform remote control of the mobile object has been made (see PTL 4, for example). On the mobile object side, a signal that controls the operation of the mobile object is received to control the operation of the mobile object itself, a signal that controls the equipped imaging device is received to control the imaging operation, and a video signal and an audio signal that the imaging device outputs are transmitted to the wearable PC. Meanwhile, on the wearable PC side, a signal that controls the operation of the mobile object is generated in accordance with the control of the operator and, furthermore, a signal that controls the operation of the imaging device in accordance with the voice of the operator is generated. The signals are wirelessly transmitted to the mobile object and an output signal of the imaging device is wirelessly received to reproduce a video signal. The video signal is displayed on the monitor screen.

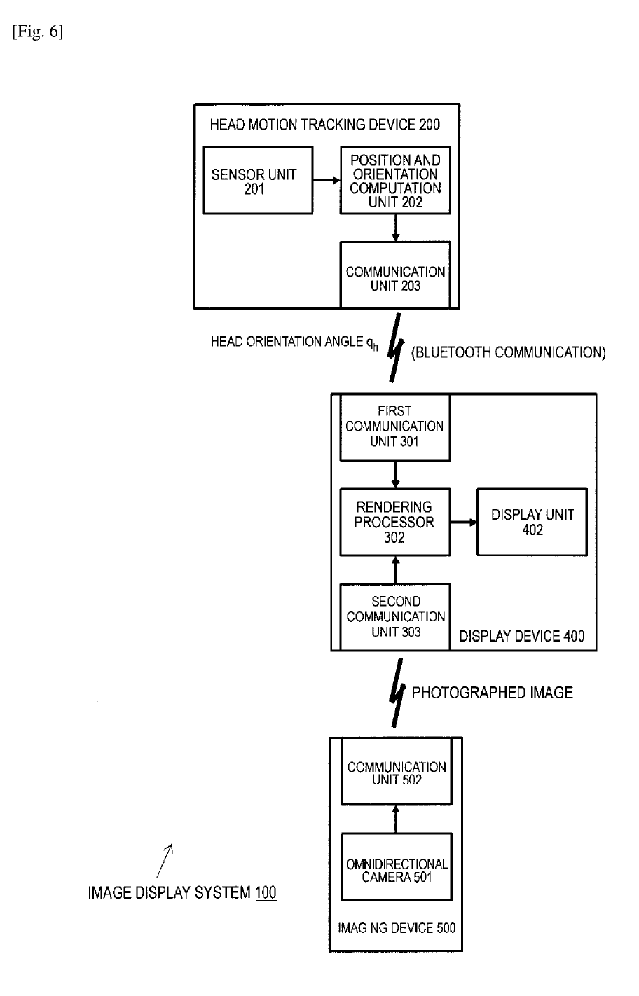

FIG. 6 illustrates an exemplary functional configuration of the image display system 100 illustrated in FIG. 5. The illustrated image display system 100 includes three devices, namely, the head motion tracking device 200 that is mounted on the head of the user, the display device 400 that is worn on the head or the face of the user, the imaging device 500 that is equipped in the mobile object (not shown in FIG. 6).

The head motion tracking device 200 is used by being mounted on the head of the user viewing an image displayed with the display device 400 and outputs position and orientation information of the head of the user at predetermined transmission periods to the display device 400. In the illustrated example, the head motion tracking device 200 includes the sensor unit 201, the position and orientation computation unit 202, and the communication unit 203.

The sensor unit 201 is constituted by combining a plurality of sensor elements such as a gyro sensor, an acceleration sensor, and a geomagnetic sensor and detects the orientation angle of the head of the user. Herein, the sensors are a triaxial gyro sensor, a triaxial acceleration sensor, and a triaxial geomagnetic sensor that are capable of detecting nine axes in total. The position and orientation computation unit 202 computes the position and orientation information of the head of the user on the basis of the result of the detection in nine axes with the sensor unit 201.

The head motion tracking device 200 and the display device 400 are interconnected through wireless communication such as Bluetooth (registered trademark) communication. Alternatively, rather than through wireless communication, the head motion tracking device 200 and the display device 400 may be connected to each other through a high-speed cable interface such as a Universal Serial Bus (USB). The position and orientation information of the head of a user that has been obtained in the position and orientation computation unit 202 is transmitted to the display device 400 through the communication unit 203.

The imaging device 500 includes an omnidirectional camera 501 and a communication unit 502 and is used by being equipped in the mobile device 600.

The omnidirectional camera 501 is configured by, for example, disposing a plurality of cameras radially so that the main axis directions thereof are each oriented outwards; accordingly, the imaging range is made omnidirectional. Note that regarding an example of the specific configuration of the omnidirectional camera that can be applied to the image display system 100 according to the present embodiment, refer to the description of the Patent Application No. 2014-128020 that has already been assigned to the present applicant. However, an embodiment of the technology disclosed in the present description is not limited to a configuration of a specific omnidirectional camera.

The imaging device 500 and the display device 400 are interconnected through wireless communication such as Wireless Fidelity (Wi-Fi). Image information taken by the omnidirectional camera 501 is transmitted to the display device 400 through the communication unit 502.

The display device 400 is configured as a head mounted display, for example. In the example illustrated in FIG. 6, the head motion tracking device 200 is configured as an independent device with respect to the display device 400 (for example, the head motion tracking device 200 is manufactured and sold as an optional product of the head mounted display); however, the head mounted display may be configured such that the head motion tracking device 200 and the display device 400 are integral with each other.

The display device 400 includes the first communication unit 301, the second communication unit 303, the rendering processor 302, and the display unit 402.

When the display device 400 is configured as a head mounted display, the display unit 402 will include, for example, left and right screens that are fixed to the left and right eyes of the user such that an image for the left eye and an image for the right eye are displayed. The display unit 402 is configured by a display panel such as a micro display including an organic electro-luminescence (EL) device or a liquid crystal display, or a laser scanning display such as a direct imaging retina display, for example. Furthermore, the display unit 402 includes a virtual image optical unit (not shown) that magnifies and projects a display image of the display unit 402 and that forms a magnified virtual image having a predetermined angle of view in the pupils of the user.

The first communication unit 301 receives position and orientation information of the head of the user from the head motion tracking device 200 through the communication unit 203. Furthermore, the first communication unit 301 receives image information taken by the omnidirectional camera 501 from the second communication unit 303 and the imaging device 500 through the communication unit 502.

The rendering processor 302 renders, from the omnidirectional image, an image that has been extracted so as to have a display angle of view that corresponds to the position and orientation information of the head of the user. In the display unit 402, a display area in the original image is moved so as to cancel out the orientation angle of the head of the user such that an image that follows the movement of the head can be reproduced and the user can have an experience of looking out over a large screen.

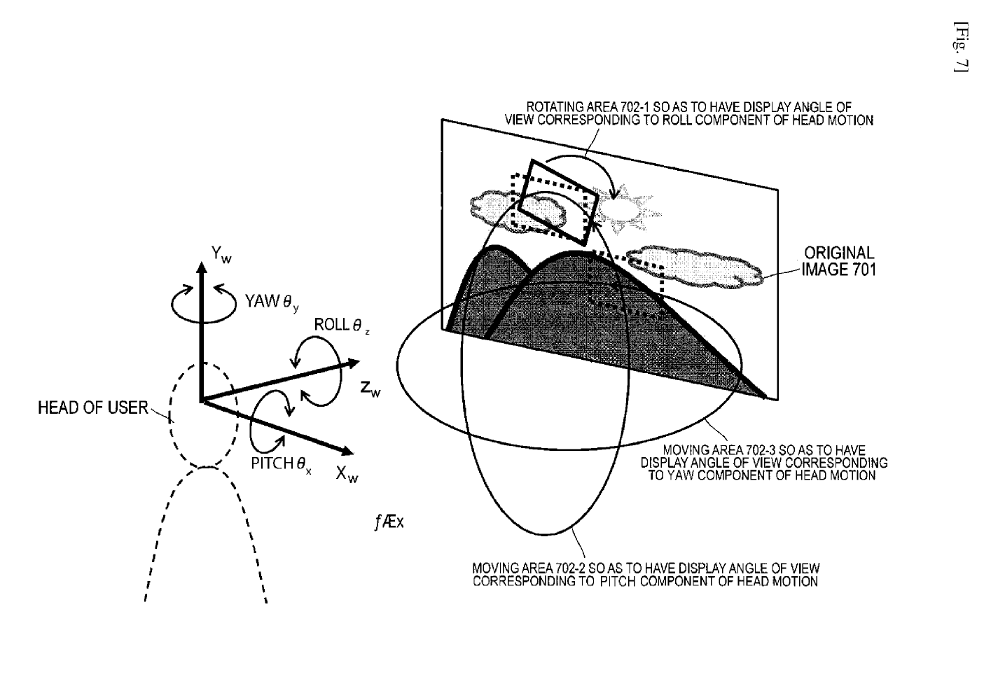

In FIG. 7, a mechanism for displaying an image, which follows the movement of the head of the user, with the display device 400 in the image display system 100 described above is illustrated.

[Math.1]
The depth direction of the line of sight of the user is a z_{w} axis, the horizontal direction thereof is a x_{w} axis, and the vertical direction thereof is an y_{w} axis. The origin position of the reference axes y_{w}, x_{w}, and z_{w}, of the user is the viewpoint position of the user. Accordingly, the roll θ_{z} corresponds to a motion of the head of the user about the z_{w} axis, the pitch θₓ corresponds to a motion of the head of the user about the x_{w} axis, and the yaw θ_{y} corresponds to a motion of the head of the user about the y_{w} axis.

[Math.2]
The head motion tracking device 200 detects the movement (θ_{z}, θ_{y}, θₓ) of the head of the user in each of the rolling, pitching and yawing directions and the orientation information configured by parallel displacement of the head and outputs the above to the rendering device 300.

The rendering device 300 moves the center of an area 702 that is to be extracted from an omnidirectional image or an original 4K image 701 having a wide angle of view, for example, so as to follow the orientation of the head of the user and renders an image of the area 702 that has been extracted so as to have a predetermined angle of view around the above center position. The rendering device 300 rotates an area 702-1 in accordance with a roll component of the head motion of the user, moves an area 702-2 in accordance with a tilt component of the head motion of the user, and moves an area 702-3 in accordance with a pan component of the head motion of the user such that the display area is moved so as to cancel out the movement of the head that has been detected by the head motion tracking device 200. On the display device 400 side, an image in which the display area moves in the original image 701 so as to follow the movement of the head of the user can be presented.

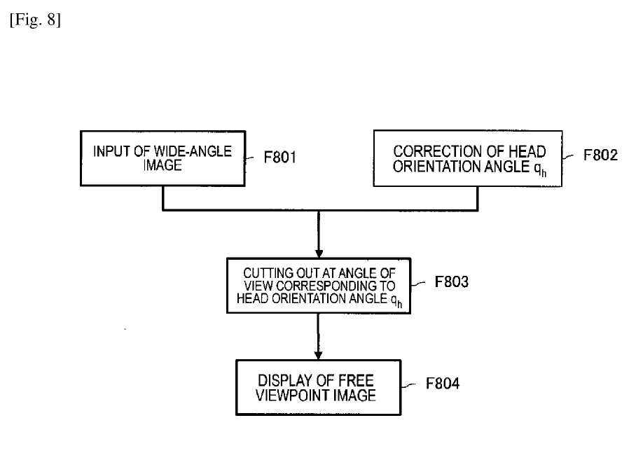

In FIG. 8, a procedure for cutting out, from a wide field-of-view image, an image having a display angle of view that matches the position and orientation of the head of the user is illustrated.

In the rendering device 300, a wide field-of-view image is input from the image source 304 (F801). Meanwhile, in the head motion tracking device 200, the sensor unit 201 detects the orientation angle of the head of the user and, on the basis of the result of the detection by the sensor unit 201, the position and orientation computation unit 202 computes an orientation angle qₕ of the head of the user (F802). Then, the computed head orientation angle qₕ is transmitted to the rendering device 300 through the communication unit 203.

On the rendering device 300 side, when the head orientation angle qₕ of the user from the head motion tracking device 200 is received in the first communication unit 301, the rendering processor 302 cuts out, from the wide field-of-view image, a display angle of view corresponding to the head orientation angle qₕ of the user and renders an image (F803). When rendering the image, scaling and deformation may be performed. An image in which the display angle of view is changed in accordance with the viewpoint position and the angle of visibility of the user is referred to as a “free viewpoint image”. Then, the rendering device 300 transmits the free viewpoint image that the rendering processor 302 has rendered to the display device 400 through the first communication unit 301 and displaying is performed in the display device 400 (F804).

As illustrated in FIGS. 7 and 8, in the image display system 100 according to the present embodiment, an angle of visibility is computed in accordance with position and orientation information of the head of the user detected by the head motion tracking device 200 and a display angle of view that matches the angle of visibility is extracted from the original wide field-of-view image.

Incidentally, in the image display system 100, when the user is viewing the free viewpoint image or the wide field-of-view image, it is not possible for the user to avert seeing an image that may cause simulation sickness unintended by the user. In particular, when the display device 400 is, as is the case of the head mounted display, used while being fixed to the head or the face of the user, simulation sickness is easily caused even in a relatively short time.

Accordingly, in an embodiment of the technology disclosed in the present description, an abnormal image that may cause simulation sickness is automatically detected such that an appropriate simulation sickness prevention operation is achieved.

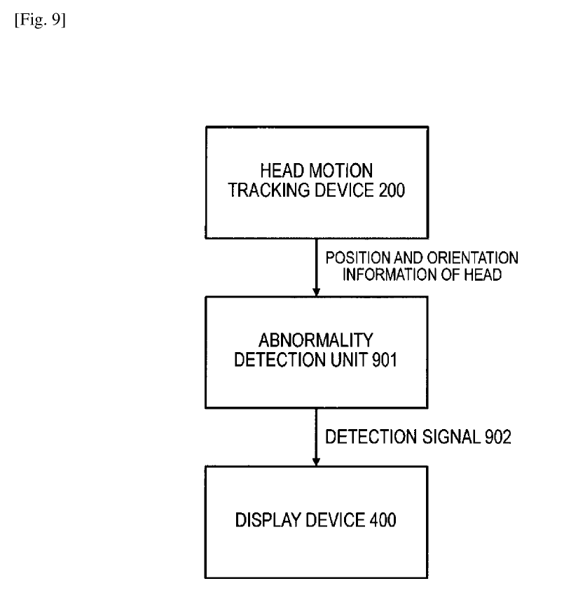

FIG. 9 illustrates an exemplary functional configuration that automatically detects an abnormal image. The illustrated abnormality detection function can be incorporated in the rendering processor 302, for example.

An abnormality detection unit 901, input with the position and orientation information of the head from the head motion tracking device 200, detects whether the free viewpoint image that has been rendered with the procedure illustrated in FIGS. 7 and 8 is an image that may cause simulation sickness that is unintended by the user.

[Math.3]
As illustrated in Ha 10, a three-dimensional position (x, y, and z) and an orientation (a yaw angle θ, a pitch angle θ, and a roll angle ψ) of the head (or the eyes) of the user to which the display device 400 is fixed are defined. The abnormality detection unit 901 computes, moment by moment, movement amounts Δx, Δy, and Δz of the head in each direction per unit time and rotation amounts Δφ, Δθ, and Δψ of the head rotating about each axis per unit time and, as in the following expression (1), compares the magnitude between the computed movement amounts and threshold values xₜₕ, yₜₕ, and zₜₕ that have been set for each direction and compares the magnitude between the computed rotation amounts and threshold values φₜₕ, θₜₕ, and ψₜₕ set for each axis. Then, if either one of the components or if a predetermined number or more components exceed the corresponding threshold value or threshold values, the abnormality detection unit 901 detects that the free viewpoint image will become a free viewpoint image that causes simulation sickness that is unintended by the user.

$$\begin{matrix}[ Math . 4 ] & \\ \begin{matrix}\vert Δ x \vert > {x}_{th} \\ \vert Δ y \vert > {y}_{th} \\ \vert Δ z \vert > {z}_{th}\end{matrix} , \begin{matrix}\vert Δ θ \vert > {θ}_{th} \\ \vert Δ φ \vert > {φ}_{th} \\ \vert Δ ψ \vert > {ψ}_{th}\end{matrix} \} & ( 1 )\end{matrix}$$

[Math.5]
In addition to comparing the magnitude with the threshold values that have been set individually for each of the directions and around each of the axes, the movements P=(Δx, Δy, and Δz) of the head per unit time and the rotations r=(Δφ, Δθ, and Δψ) of the head per unit time are computed moment by moment, and: as illustrated in the following expression (2), an absolute value |P| and a norm ∥P∥ of the movement of the head per unit time and an absolute value |r| and a norm ∥r∥ of the rotation of the head per unit time are compared in magnitude with threshold values Pₜₕ and rₜₕ that have been set in advance for the above Then, if either one or both exceed the corresponding threshold value or threshold values, the abnormality detection unit 901 detects that the free viewpoint image will become a free viewpoint image that causes simulation sickness that is unintended by the user.

[Math.6]

|\vec{P}|>Pₜₕ |\vec{r}>rₜₕ

∥\vec{P}∥>Pₜₕ, ∥\vec{r}∥>rₜₕ (2)

For example, when the sensor unit 201 is forcibly moved or when a malfunction occurs in the sensor unit 201 or the position and orientation computation unit 202, the abnormality detection unit 901 detects that the free viewpoint image will become an abnormal free viewpoint image on the basis of the above equations (1) and (2).

When detecting that the free viewpoint image will become an abnormal free viewpoint image, the abnormality detection unit 901 outputs a detection signal 902 to the display device 400 (or the display unit 402) and instructs an appropriate simulation sickness prevention operation to be executed. Note that the details of the simulation sickness prevention operation will be described later.

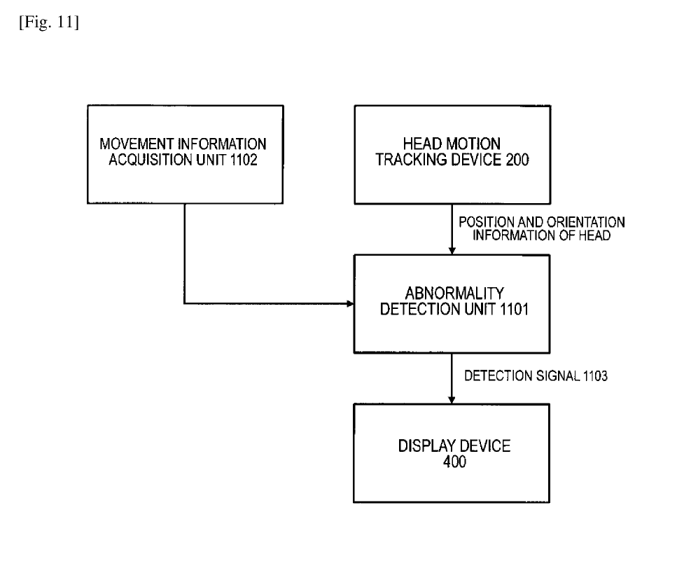

Furthermore, FIG. 11 illustrates another exemplary functional configuration that automatically detects an abnormal image. The illustrated abnormality detection function can be incorporated in the rendering processor 302, for example.

An abnormality detection unit 1101, input with the position and orientation information of the head from the head motion tracking device 200, detects whether the free viewpoint image that has been rendered with the procedure illustrated in FIGS. 7 and 8 is an image that may cause simulation sickness that is unintended by the user. The difference with the exemplary configuration illustrated in FIG. 9 is that a movement information acquisition unit 1102 that acquires movement information is provided.

The movement information that the movement information acquisition unit 1102 acquires is information related to the movement of the image of the original contents on which the rendering processor 302 performs processing, such as the free viewpoint image, and is provided as metadata accompanying the contents, for example.

[Math.7]

The movement information includes, for example, the threshold values xₜₕ, yₜₕ, zₜₕ, φₜₕ, θₜₕ, ψₜₕ of the movement amounts Δx, Δy, and Δz in each direction per unit time and the rotation amounts Δφ, Δθ, and Δψ about each axis per unit time. Providing the information of the threshold values as metadata of the contents is advantageous in that a creator of the contents can instruct threshold values that are to be detected as abnormal to the viewer side of the contents. For example: if the creator of the contents wants the image to be viewed as an image with intense movement, then, threshold values each set at a large value may be stored in the metadata of the contents as the movement information.
[Math.8]
Furthermore, the threshold values provided as the movement information may be time functions xₜₕ(t), yₜₕ(t), zₜₕ(t), φₜₕ(t), θₜₕ(t), ψₜₕ(t), Pₜₕ(t), and rₜₕ(t). In such a case, as illustrated in the following expressions (3) and (4), the abnormality detection unit 1101 performs abnormality detection of the image by comparing the magnitude between the position and orientation information of the head that has been measured by the head motion tracking device 200 and each of the threshold values that are time functions

$$\begin{matrix}[ Math . 9 ] & \\ \begin{matrix}\vert Δ x \vert > {x}_{th} ( t ) & \vert Δ θ \vert > {θ}_{th} ( t ) \\ \vert Δ y \vert > {y}_{th} ( t ) , & \vert Δ φ \vert > {φ}_{th} ( t ) \\ \vert Δ z \vert > {z}_{th} ( t ) & \vert Δ ψ \vert > {ψ}_{th} ( t )\end{matrix} \} & ( 3 ) \\ [ Math . 10 ] & \\ \begin{matrix}\vert \vec{P} \vert > {P}_{th} ( t ) \\ ‖ \vec{P} ‖ > {P}_{th} ( th )\end{matrix} , \begin{matrix}\vert \vec{r} \vert > {r}_{th} ( t ) \\ ‖ \vec{r} ‖ > {r}_{th} ( th )\end{matrix} & ( 4 )\end{matrix}$$

[Math.11]
Configuring the threshold values as the time functions xₜₕ(t), yₜₕ(t), zₜₕ(t), φₜₕ(t), θₜₕ(t), ψₜₕ(t), Pₜₕ(t), and rₜₕ(t) is advantageous in that a creator of the contents can, per each scene, instruct threshold values that are to be detected as abnormal to the viewer side of the contents, for example. For example, for the scene that is desired, by the creator of the contents, to be viewed as au image with intense movement, threshold values each set at a large value may be stored in the metadata of the contents as the movement information.

When detecting that the free viewpoint image will become an abnormal free viewpoint image, the abnormality detection unit 1101 outputs a detection signal 1103 to the display device 400 (or the display unit 402) and instructs an appropriate simulation sickness prevention operation to be executed. Note that the details of the simulation sickness prevention operation will be described later.

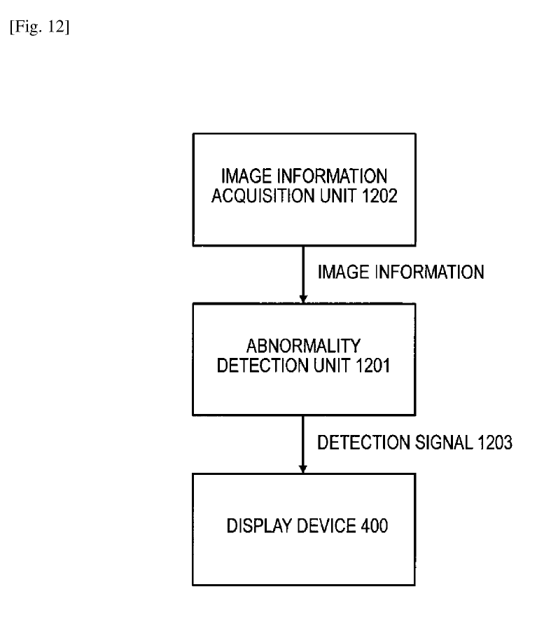

Furthermore, FIG. 12 illustrates further another exemplary functional configuration that automatically detects an abnormal image. The illustrated abnormality detection function may be incorporated in the rendering processor 302, for example.

The image information acquisition unit 1202 acquires image that is to be displayed on the display device 400 from the image source 304. For example, an image that has been reproduced with a Blu-ray disc player is acquired. Then, an abnormality detection unit 1201 analyzes the image that the image information acquisition unit 1202 has acquired and detects whether the image is an image that causes simulation sickness that is unintended by the user.

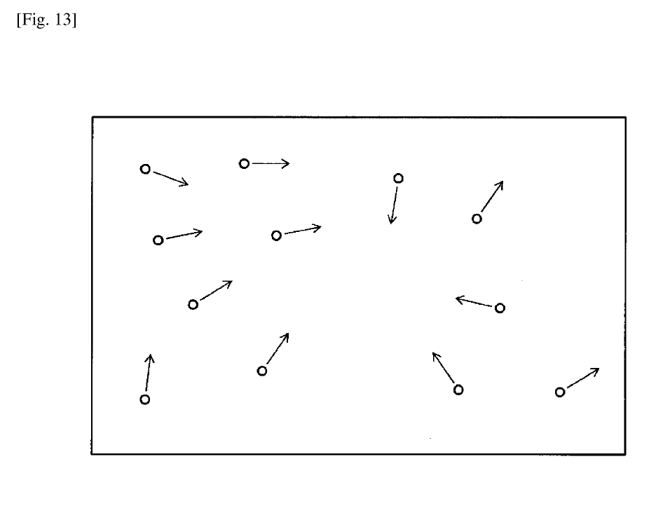

As illustrated in FIG. 13, in a moving image, each of the picture elements has a different optical flow. The abnormality detection unit 1201 computes, moment by moment, the mean value F=(Fₓ,F_{y}) of the optical flow inside the screen and, as set forth in the following expression (5), absolute values of each of the components Fₓ and F_{y} of the mean value F of the optical flow, an absolute value and a norm of the optical flow F are compared in magnitude with threshold values that have been set for each of the above.

$$\begin{matrix}[ Math . 12 ] & \\ \begin{matrix}\vert {F}_{x} \vert > {F}_{xth} \\ \vert {F}_{y} \vert > {F}_{yth} \\ \vert \vec{F} \vert > {F}_{th} \\ ‖ \vec{F} ‖ > {F}_{th}\end{matrix} \} & ( 5 )\end{matrix}$$

Then, if either one of the components or if a predetermined number or more components exceed the corresponding threshold value or threshold values, the abnormality detection unit 1201 detects that an abnormal image will be displayed on the display device 400, outputs a detection signal 1203 to the display device 400 (or the display unit 402), and instructs an appropriate simulation sickness prevention operation to be executed.

Note that the image display system 100 may be operated by combining the functional configuration illustrated in FIG. 12 that detects an abnormal image with the functional configuration illustrated in FIG. 9 or FIG. 11.

The simulation sickness prevention operation that is performed in the display device 400 in accordance with the detection of abnormality in the image will be exemplified below.

(1) The display unit 402 is blacked out.

(2) A message screen indicating that abnormality has been detected is displayed.

(3) Display of the moving image is temporarily stopped.

(4) Following of the position and orientation of the head in the free viewpoint image is temporarily stopped.

(5) Video see-through display is performed.

(6) Power of the display device 400 is turned off.

(7) The state in which the display device 400 is fixed to the head or face of the user is canceled.

Among the above, (1) to (6) responding to the abnormality detection of the image control the display in the display unit 402 and prevents simulation sickness unintended by the user from occurring. (1) to (4) and (6) can be applied to display devices in general (including large-screen displays and multifunctional terminals such as smart phones and tablet computers) that display an image following the head motion. Conversely, (5) is a method for performing a video see-through display by performing imaging of the scenery in the visual line direction of the user with an outside camera when the display device 400 is configured as a head mounted display (see FIGS. 3 and 4). The user not only can avert an image causing unintended simulation sickness, but also can avoid danger by indirectly viewing the scenery of the actual world.

Furthermore, while (1) to (6) prevents simulation sickness unintended by the user from occurring through signal processing, (7) is a method that uses a mechanical operation. When the display device 400 is configured as a head mounted display (see FIGS. 3 and 4), the above can be achieved by a mechanism in which, for example, the fitted head mounted display is taken off or, rather than the whole head mounted display, only the display units are taken off. For example, a head mounted display has been proposed (see PTL 5, for example) in which a display surface is supported in an openable and closable manner with a movable member and is set to an open state such that the head mounted display is set to a second state that allows the peripheral visual field of the user to be obtained. The above head mounted display can be applied to an embodiment of the technology disclosed in the present description.

As described above, according to an embodiment of the technology disclosed in the present description, when a user is viewing an image while fixing a display device such as a head mounted display on the head or the face, image which may cause unintended simulation sickness can be avoided from being seen and VR sickness can be alleviated greatly.

### CITATION LIST

### Patent Literature

PTL 1: JP 2012-141461A
PTL 2: JP H9-106322A
PTL 3: JP 2010-256534A
PTL 4: JP 2001-209426A
PTL 5: JP 2013-200325A

### INDUSTRIAL APPLICABILITY

It should be understood by those skilled in the art that various modifications, combinations, sub-combinations and alterations may occur depending on design requirements and other factors insofar as they are within the scope of the appended claims or the equivalents thereof.

An embodiment of the technology disclosed in the present description can be preferably applied to cases in which a free viewpoint image or a wide field-of-view image are viewed with an immersive head mounted display; however, needless to say, the technology can be applied to a transmission type head-mounted display as well.

While the present description mainly describes an embodiment in which the technology disclosed in the present description is applied to a binocular video see-through type head mounted display, an embodiment of the technology disclosed in the present description may be applied to a monocular head mounted display and an optical see-through type head mounted display in a similar manner.

Furthermore, an embodiment of the technology disclosed in the present description may be applied in a similar manner to a case in which the free viewpoint image is viewed not with a head mounted display but by fixing the screen of an information terminal, such as a smartphone or a tablet computer, on the head or the face and, furthermore, in a case in which an image with a wide angle of visibility is viewed with a large-screen display.

In short, the present technology has been disclosed in a form of illustration and should not be interpreted limitedly. To determine the gist of the present disclosure, patent claims should be taken into account.

The present technology may also be configured as below.

(1) An image processing apparatus including:

a control device configured to: detect an abnormality in accordance with at least one of (i) position or orientation information of a display or (ii) information indicating movement of an image of contents to be displayed to the display; and generate a free viewpoint image in accordance with the image of contents and the position or orientation information of the display.

(2) The apparatus according to (1),

wherein the apparatus is included in a wearable, head mounted display.

(3) The apparatus according to (1) or (2),

wherein, when the abnormality is detected, the control device controls execution of an operation for prevention of simulation sickness.

(4) The apparatus according to any of (1) to (3),

wherein the operation for prevention of simulation sickness includes at least one of blacking out the display, displaying a message screen indicating that the abnormality is detected, temporarily stopping display of the image of contents, temporarily stopping the generating of the free viewpoint image in accordance with the position or orientation information, causing the display to be see-through, turning off power of the display or canceling a state in which the display is fixed to a head or face of a user.

(5) The apparatus according to any of (1) to (4),

wherein the information indicating the movement of the image of the contents is provided as metadata accompanying the contents.

(6) The apparatus according to any of (1) to (5),

wherein the free viewpoint image is generated from an omnidirectional image or a wide field-of-view image.

(7) The apparatus according to any of (1) to (6),

wherein the free viewpoint image is an image of an area extracted from the omnidirectional image or the wide field-of-view such that the free viewpoint image has a predetermined angle of view around a center of the area.

(8) The apparatus according to any of (1) to (7),

wherein the position or orientation information of the display is indicated in information from a sensor.

(9) The apparatus according to any of (1) to (8),

wherein the information from the sensor indicates movement of the display in a direction and orientation of the display.

(10) The apparatus according to any of (1) to (9),

wherein the information from the sensor indicates movement of a head of a user in a direction and orientation of the head of the user.

(11) The apparatus according to any of (1) to (10)

wherein the abnormality is detected using a threshold value of at least one of movement or rotation of the display.

(12) The apparatus according to any of (1) to (11),

wherein the control device detects the abnormality using a threshold value of at least one of an absolute value or a norm value of at least one of movement or rotation of the display per unit time.

(13) The apparatus according to any of (1) to (12),

wherein the control device detects the abnormality using a value of optical flow of a picture element in the image.

(14) The apparatus according to any of (1) to (13),

wherein the control device detects the abnormality by comparing the value of the optical flow of the picture element in the image with a threshold value.

(15) The apparatus according to any of (1) to (14),

wherein the control device controls displaying of the free viewpoint image in accordance with the detecting of the abnormality.

(16) The apparatus according to any of (1) to (15),

wherein the displaying is to a screen of a display other than a head mounted display.

(17) An image processing method including:

detecting, by a processing device, an abnormality in accordance with at least one of (i) position or orientation information of a display or (ii) information indicating movement of an image of contents to be displayed to the display; and generating, by the processing device, a free viewpoint image in accordance with the image of contents and the position or orientation information of the display.

(18) A non-transitory storage medium recorded with a program executable by a computer, the program including:

detecting an abnormality in accordance with at least one of (i) position or orientation information of a display or (ii) information indicating movement of an image of contents to be displayed to the display; and generating a free viewpoint image in accordance with the image of contents and the position or orientation information of the display.

(19) An image processing apparatus including:

a control device configured to: detect an abnormality in accordance with information indicating movement of an image of contents to be displayed, using a threshold value indicated in metadata related to the contents.

(20) The apparatus according to (19),

wherein the metadata is provided accompanying the contents.

(21) The apparatus according to (19) or (20),

wherein the threshold value is at least one of a movement amount in a direction per unit time or a rotation amount about an axis per unit.

(22) The apparatus according to any one of (19) to (21),

wherein the threshold value is a time function associated with a scene of the contents.

(23) The apparatus according to any one of (19) to (22),

wherein the apparatus is included in a wearable, head mounted display.

(24) An image processing method including:

detecting, by a processing device, an abnormality in accordance with information indicating movement of an image of contents to be displayed, using a threshold value indicated in metadata of the contents.

### REFERENCE SIGNS LIST

100 image display system
200 head motion tracking device
201 sensor unit
202 position and orientation computation unit
203 communication unit
300 rendering device
301 first communication unit
302 rendering processor
303 second communication unit
304 image source
400 display device
401 communication unit
402 display unit
500 imaging device
501 omnidirectional camera
502 communication unit
600 mobile device
700 controller
901 abnormality detection unit
1101 abnormality detection unit
1102 movement information acquisition unit
1201 abnormality detection unit
1203 image information acquisition unit

1. An image processing apparatus comprising:
a control device configured to:
detect an abnormality in accordance with at least one of (i) position or orientation information of a display or (ii) information indicating movement of an image of contents to be displayed to the display; and
generate a free viewpoint image in accordance with the image of contents and the position or orientation information of the display.

2. The apparatus of claim 1, wherein the apparatus is included in a wearable, head mounted display.

3. The apparatus of claim 1, wherein, when the abnormality is detected, the control device controls execution of an operation for prevention of simulation sickness.

4. The apparatus of claim 3, wherein the operation for prevention of simulation sickness includes at least one of blacking out the display, displaying a message screen indicating that the abnormality is detected, temporarily stopping display of the image of contents, temporarily stopping the generating of the free viewpoint image in accordance with the position or orientation information, causing the display to be see-through, turning off power of the display or canceling a state in which the display is fixed to a head or face of a user.

5. The apparatus of claim 1, wherein the information indicating the movement of the image of the contents is provided as metadata accompanying the contents.

6. The apparatus of claim 1, wherein the free viewpoint image is generated from an omnidirectional image or a wide field-of-view image.

7. The apparatus of claim 6, wherein the free viewpoint image is an image of an area extracted from the omnidirectional image or the wide field-of-view such that the free viewpoint image has a predetermined angle of view around a center of the area.

8. The apparatus of claim 1, wherein the position or orientation information of the display is indicated in information from a sensor.

9. The apparatus of claim 8, wherein the information from the sensor indicates movement of the display in a direction and orientation of the display.

10. The apparatus of claim 8, wherein the information from the sensor indicates movement of a head of a user in a direction and orientation of the head of the user.

11. The apparatus of claim 1, wherein the abnormality is detected using a threshold value of at least one of movement or rotation of the display.

12. The apparatus of claim 1, wherein the control device detects the abnormality using a threshold value of at least one of an absolute value or a norm value of at least one of movement or rotation of the display per unit time.

13. The apparatus of claim 1, wherein the control device detects the abnormality using a value of optical flow of a picture element in the image.

14. The apparatus of claim 13, wherein the control device detects the abnormality by comparing the value of the optical flow of the picture element in the image with a threshold value.

15. The apparatus of claim 1, wherein the control device controls displaying of the free viewpoint image in accordance with the detecting of the abnormality.

16. The apparatus of claim 13, wherein the displaying is to a screen of a display other than a head mounted display.

17. An image processing method comprising:
detecting, by a processing device, an abnormality in accordance with at least one of (i) position or orientation information of a display or (ii) information indicating movement of an image of contents to be displayed to the display; and
generating, by the processing device, a free viewpoint image in accordance with the image of contents and the position or orientation information of the display.

18. A non-transitory storage medium recorded with a program executable by a computer, the program comprising:
detecting an abnormality in accordance with at least one of (i) position or orientation information of a display or (ii) information indicating movement of an image of contents to be displayed to the display; and
generating a free viewpoint image in accordance with the image of contents and the position or orientation information of the display.

19. An image processing apparatus comprising:
a control device configured to:
detect an abnormality in accordance with information indicating movement of an image of contents to be displayed, using a threshold value indicated in metadata related to the contents.

20. The apparatus of claim 19, wherein the metadata is provided accompanying the contents.

21. The apparatus of claim 19, wherein the threshold value is at least one of a movement amount in a direction per unit time or a rotation amount about an axis per unit.

22. The apparatus of claim 19, wherein the threshold value is a time function associated with a scene of the contents.

23. The apparatus of claim 19, wherein the apparatus is included in a wearable, head mounted display.

24. An image processing method comprising:
detecting, by a processing device, an abnormality in accordance with information indicating movement of an image of contents to be displayed, using a threshold value indicated in metadata of the contents.
